(19) United States
(12) Patent Application Publication
(10) Pub. No.: US 2026/0346621 A1
(43) Pub. Date: Nov. 5, 2026

(54) DRYING DEVICE AND LIQUID DISCHARGE APPARATUS

(71) Applicants: Hideaki SUZUKI, Kanagawa (JP); Teppei KIKUCHI, Kanagawa (JP); Er Sin KHOO, Kanagawa (JP)

(72) Inventors: Hideaki SUZUKI, Kanagawa (JP); Teppei KIKUCHI, Kanagawa (JP); Er Sin KHOO, Kanagawa (JP)

(21) Appl. No.: 19/636,962

(22) Filed: Apr. 2, 2026

(30) Foreign Application Priority Data
Apr. 30, 2025 (JP) 2025-075531

(51) Int. Cl. B41J 11/00

(52) U.S. Cl. CPC B41J 11/0022; B41J 11/007; B41J 11/0085

(57) ABSTRACT

A drying device dries liquid adhered to a liquid bearing medium. The drying device includes a drying chamber, a conveyor, and a supplier. The conveyor conveys the liquid bearing medium adhered with the liquid through the drying chamber. The supplier is disposed below the drying chamber and supplies superheated steam into the drying chamber.

### CROSS-REFERENCE TO RELATED APPLICATION

This patent application is based on and claims priority pursuant to 35 U.S.C. § 119(a) to Japanese Patent Application No. 2025-075531, filed on Apr. 30, 2025, in the Japan Patent Office, the entire disclosure of which is hereby incorporated by reference herein.

### BACKGROUND

### Technical Field

The present disclosure relates to a drying device and a liquid discharge apparatus, and more particularly, to a drying device and a liquid discharge apparatus incorporating the drying device.

### Related Art

Related-art image forming apparatuses, such as copiers, facsimile machines, printers, and multifunction peripherals (MFP) having two or more of copying, printing, scanning, facsimile, plotter, and other functions, typically form an image on a recording medium according to image data.

Such image forming apparatuses include a liquid discharge apparatus that includes a drying device that dries liquid adhered to a liquid bearing medium.

### SUMMARY

The present disclosure described herein provides a drying device that dries liquid adhered to a liquid bearing medium. The drying device includes a drying chamber, a conveyor, and a supplier. The conveyor conveys the liquid bearing medium adhered with the liquid through the drying chamber. The supplier is disposed below the drying chamber and supplies superheated steam into the drying chamber.

The present disclosure described herein further provides a liquid discharge apparatus that includes a liquid discharger that discharges liquid onto a liquid bearing medium and the drying device described above.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic cross-sectional view of an image forming system according to an embodiment of the present disclosure, illustrating a construction thereof as one example;

FIG. 2 is a schematic front view of a drying device incorporated in the image forming system depicted in FIG. 1, illustrating a construction of the drying device;

FIG. 3 is a schematic plan view of the drying device depicted in FIG. 2, illustrating the construction thereof; and

FIG. 4 is a schematic front view of a drying device incorporating a heater, as a modification example of the drying device depicted in FIG. 2.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

The following describes a construction of a drying device according to an embodiment of the present disclosure that is applied to an image forming system serving as a liquid discharge apparatus, an inkjet recording apparatus, or an image forming apparatus.

The drying device according to the embodiment of the present disclosure dries liquid that is discharged from a liquid discharger of the liquid discharge apparatus and adhered to a liquid bearing medium. Alternatively, the drying device may be applied to other apparatuses, such as a printer, to dry liquid adhered to a liquid bearing medium. In a case that the drying device is applied to the liquid discharge apparatus, the drying device is not restricted by a construction, an operation, a method, and the like of the liquid discharge apparatus.

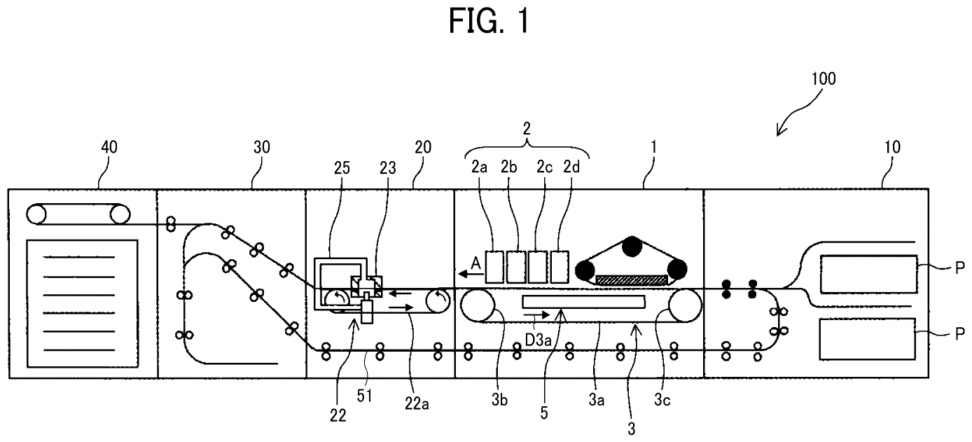

FIG. 1 is a schematic cross-sectional view of an image forming system 100 according to an embodiment of the present disclosure as one example.

The image forming system 100 according to the embodiment includes an image forming device 1 that includes a liquid discharge unit 2, a conveying device 3, and an air suction unit 5. The liquid discharge unit 2 includes liquid discharge heads 2a, 2b, 2c, and 2d serving as liquid dischargers that discharge ink (e.g., liquid) by an inkjet method. The conveying device 3 conveys a sheet P serving as a recording medium or a liquid bearing medium.

The conveying device 3 includes a conveyance belt 3a and two support rollers 3b and 3c. The liquid discharge unit 2 is disposed opposite a front face (e.g., an outer circumferential face) of the conveyance belt 3a of the conveying device 3. The four liquid discharge heads 2a, 2b, 2c, and 2d are arranged in a sheet conveyance direction A. The conveyance belt 3a is stretched across the two support rollers 3b and 3c. One of the support rollers 3b and 3c serves as a driving roller that is driven to drive and rotate the conveyance belt 3a. The conveyance belt 3a conveys the sheet P borne on the front face of the conveyance belt 3a. The air suction unit 5 is disposed opposite a back face (e.g., an inner circumferential face) of the conveyance belt 3a. The air suction unit 5 sucks air from the back face of the conveyance belt 3a, adhering the sheet P to the front face of the conveyance belt 3a.

The image forming system 100 further includes a sheet feeder 10 that is disposed upstream from the image forming device 1 in the sheet conveyance direction A. The sheet feeder 10 loads a plurality of sheets P and supplies the sheets P to the image forming device 1. The image forming system 100 further includes a drying device 20 that is disposed downstream from the image forming device 1 in the sheet conveyance direction A. The drying device 20 dries the sheet P bearing an image formed with ink discharged from the liquid discharge heads 2a, 2b, 2c, and 2d of the liquid discharge unit 2. The image forming system 100 further includes an output device 40 that is disposed downstream from the drying device 20 in the sheet conveyance direction A. The output device 40 ejects the sheet P dried by the drying device 20 onto an outside of the image forming system 100. The image forming system 100 further includes a sheet reverse-conveyance device 30 that is interposed between the drying device 20 and the output device 40 in the sheet conveyance direction A. The sheet reverse-conveyance device 30 reverses and conveys the sheet P bearing the image on a front side (e.g., a first side) of the sheet P so that the image forming device 1 forms an image on a back side (e.g., a second side) of the sheet P.

A description is provided of image forming operations of the image forming system 100 according to the embodiment to form an image on a sheet P.

The sheet feeder 10 includes a sheet pickup portion such as an air separator that picks up a sheet P by using air, for example. The sheet pickup portion picks up and separates a sheet P from other sheets P placed in the sheet feeder 10 one by one. The sheet feeder 10 conveys the sheet P that is picked up downstream in the sheet conveyance direction A so that the sheet P enters the image forming device 1 at a predetermined time.

The sheet P sent to the image forming device 1 from the sheet feeder 10 is sent onto the front face of the conveyance belt 3a of the conveying device 3 inside the image forming device 1. The conveyance belt 3a is a perforated belt or a mesh belt with a substantial number of air suction holes distributed across the front face of the conveyance belt 3a. As the air suction unit 5 disposed opposite the back face of the conveyance belt 3a pulls in an entirety of the back side of the sheet P by air suction, the sheet P adheres to the front face of the conveyance belt 3a that bears the sheet P. As the conveyance belt 3a rotates in a rotation direction D3a, the conveyance belt 3a conveys the sheet P adhered to and held by the front face of the conveyance belt 3a downstream in the sheet conveyance direction A.

While the sheet P is conveyed below the liquid discharge unit 2 of the image forming device 1, nozzles of the liquid discharge heads 2a, 2b, 2c, and 2d of the liquid discharge unit 2 discharge ink droplets in different colors, respectively, onto the sheet P held by the conveyance belt 3a using air suction by the air suction unit 5 at a predetermined time. Thus, the ink droplets adhere to the front side of the sheet P, forming an image on the sheet P.

The sheet P bearing the image is conveyed to the drying device 20. The drying device 20 removes moisture of ink (e.g., the ink droplets) forming the image on the sheet P, drying the sheet P. Accordingly, the drying device 20 prevents curling and the like of the sheet P advantageously. The sheet P having passed through the drying device 20 is conveyed to the output device 40 through the sheet reverse-conveyance device 30. The sheets P are stacked and neatly aligned in the output device 40.

In a case that the image forming system 100 performs duplex printing, the sheet reverse-conveyance device 30 reverses and conveys the sheet P bearing the image on the front side (e.g., the first side) of the sheet P. The image forming system 100 further includes a sheet reverse-conveyance path 51 that is disposed in the drying device 20, the image forming device 1, and the sheet feeder 10. The sheet reverse-conveyance device 30 conveys the sheet P to the sheet reverse-conveyance path 51. The sheet P is conveyed through the sheet reverse-conveyance path 51 to a conveyance path of the sheet feeder 10. The sheet P is sent to the image forming device 1 again at a predetermined time. Accordingly, in the image forming device 1, the nozzles of the liquid discharge heads 2a, 2b, 2c, and 2d of the liquid discharge unit 2 discharge ink droplets in different colors, respectively, onto the back side (e.g., the second side) of the sheet P that is reversed at the predetermined time. The ink droplets adhere to the back side (e.g., the second side) of the sheet P, forming an image on the sheet P. Like the sheet P bearing the image on the front side of the sheet P, the sheet P bearing the images on the front side and the back side of the sheet P, respectively, passes through the drying device 20 and is conveyed to the output device 40. The sheets P are stacked and neatly aligned in the output device 40.

A description is provided of a construction of the drying device 20 according to an embodiment of the present disclosure in detail.

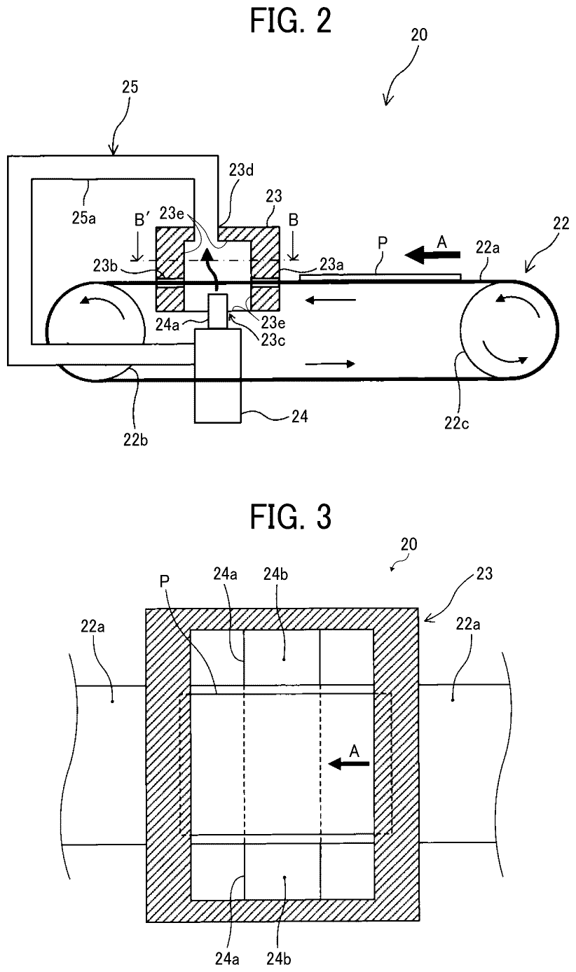

FIG. 2 is a schematic front view of the drying device 20 according to the embodiment, illustrating the construction thereof. FIG. 3 is a schematic plan view of the drying device 20 according to the embodiment, illustrating the construction thereof. FIG. 3 illustrates a cross section taken on a line B-B′ in FIG. 2.

As illustrated in FIG. 2, the drying device 20 includes a conveyor 22, a drying chamber 23, a superheated steam generator 24, and a circulator 25. The superheated steam generator 24 serves as a supplier that supplies superheated steam into the drying chamber 23. The circulator 25 discharges the superheated steam from the drying chamber 23 and returns the superheated steam to the superheated steam generator 24.

The conveyor 22 includes a conveyance belt 22a and two support rollers 22b and 22c. One of the support rollers 22b and 22c serves as a driving roller. The conveyance belt 22a is stretched across the support rollers 22b and 22c. As the driving roller is driven to drive and rotate the conveyance belt 22a, the conveyance belt 22a conveys the sheet P borne on a front face of the conveyance belt 22a. For example, the conveyance belt 22a is a metal belt. The conveyance belt 22a may be a perforated belt, a mesh belt, or the like with a substantial number of air suction holes distributed across the front face of the conveyance belt 22a. The conveyance belt 22a is preferably made of a material having an increased conductivity. For example, the conveyance belt 22a is preferably a belt made of metal such as silver.

As illustrated in FIG. 2, the conveyance belt 22a includes a belt portion that bears the sheet P and is disposed inside the drying chamber 23. As the conveyance belt 22a rotates, the conveyance belt 22a conveys the sheet P through the drying chamber 23 in a state in which the conveyance belt 22a supports a lower surface of the sheet P.

The drying chamber 23 includes an entry 23a, an exit 23b, an opening 23c, a connection port 23d, and walls 23e. The walls 23e construct a surrounding of the drying chamber 23. The entry 23a is disposed in one of the walls 23e, that is, an upstream wall in the sheet conveyance direction A. The exit 23b is disposed in another one of the walls 23e, that is, a downstream wall in the sheet conveyance direction A. The conveyance belt 22a and the sheet P borne on the conveyance belt 22a pass through the entry 23a and the exit 23b. The opening 23c is disposed in yet another one of the walls 23e, that is, a bottom wall of the drying chamber 23. The superheated steam generator 24 includes a steam outlet 24a. The opening 23c communicates with the steam outlet 24a. The circulator 25 includes an exhaust duct 25a. The connection port 23d is disposed in yet another one of the walls 23e, that is, an upper wall of the drying chamber 23. The connection port 23d communicates with the exhaust duct 25a.

As illustrated in FIG. 3, the steam outlet 24a of the superheated steam generator 24 includes a supply port 24b that supplies superheated steam that travels from below the conveyance belt 22a bearing the sheet P upward through a side of the conveyance belt 22a and fills an interior of the drying chamber 23. In order to suppress temperature decrease of the superheated steam inside the drying chamber 23, the walls 23e of the drying chamber 23 are preferably insulative thermally. For example, an inner face of each of the walls 23e is made of a thermal insulating material such as calcium silicate. Thus, the walls 23e of the drying chamber 23 attain a thermal insulation construction.

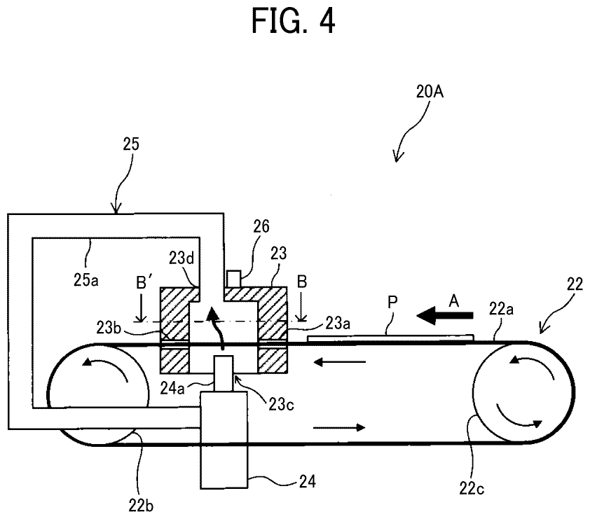

FIG. 4 illustrates a drying device 20A according to an embodiment of the present disclosure. The drying device 20A includes a heater 26 that suppresses temperature decrease of superheated steam inside the drying chamber 23. The heater 26 heats the superheated steam inside the drying chamber 23. For example, the heater 26 is preferably a microwave generator that heats the superheated steam inside the drying chamber 23 with microwave.

The conveyance belt 22a conveys the sheet P adhered with ink through the drying chamber 23 filled with superheated steam. Accordingly, the drying chamber 23 dries the ink adhered to the sheet P quickly with the superheated steam, drying the ink in a shortened time. In order to dry the ink with the superheated steam efficiently, the superheated steam inside the drying chamber 23 preferably retains a temperature not lower than 200 degrees Celsius.

In each of the drying devices 20 and 20A according to the embodiments, the steam outlet 24a of the superheated steam generator 24 protrudes beyond the bottom wall of the drying chamber 23 toward the interior thereof. The supply port 24b of the steam outlet 24a, that is, a discharge port through which superheated steam is discharged, is disposed below the sheet P borne on the conveyance belt 22a. In each of the drying devices 20 and 20A according to the embodiments, an element other than the supply port 24b of the steam outlet 24a does not supply superheated steam into the drying chamber 23. Thus, each of the drying devices 20 and 20A does not incorporate an element that supplies superheated steam from above the sheet P. That is, each of the drying devices 20 and 20A according to the embodiments has a construction that supplies superheated steam into the drying chamber 23 from below the sheet P conveyed by the conveyance belt 22a.

A construction that supplies superheated steam into the drying chamber 23 from above and below the sheet P may be assumed to dry ink adhered to the sheet P more efficiently rather than the construction that supplies superheated steam into the drying chamber 23 from below the sheet P. However, superheated steam supplied into the drying chamber 23 tends to travel upward. Hence, superheated steam supplied into the drying chamber 23 from below the sheet P generates an airflow upward inside the drying chamber 23. Additionally, superheated steam supplied into the drying chamber 23 from above the sheet P also tends to travel upward. Accordingly, in order to cause superheated steam supplied from above the sheet P to contact the sheet P, the superheated steam is to blow against an upper surface of the sheet P forcefully.

However, if the superheated steam blows against the sheet P forcefully, ink adhered to the upper surface of the sheet P may move, scatter, or disperse from the sheet P, causing failures such as image dropout. In view of the failures, the superheated steam supplied from above the sheet P is not to blow against the sheet P forcefully. Hence, even if each of the drying devices 20 and 20A incorporates the element that supplies superheated steam from above the sheet P, the superheated steam may travel upward before the superheated steam contacts the sheet P. Accordingly, the superheated steam may not dry ink adhered to the sheet P efficiently. Thus, the superheated steam may barely improve drying efficiency of each of the drying devices 20 and 20A.

Conversely, while superheated steam supplied into the drying chamber 23 from below the sheet P travels upward inside the drying chamber 23, the superheated steam comes into contact with the sheet P successively, improving drying of ink on the sheet P. For example, even with the construction that supplies superheated steam into the drying chamber 23 from above and below the sheet P, superheated steam supplied into the drying chamber 23 from below the sheet P substantially dries ink on the sheet P.

As described above, each of the drying devices 20 and 20A employs the construction that supplies superheated steam into the drying chamber 23 from below the sheet P conveyed by the conveyance belt 22a. Thus, each of the drying devices 20 and 20A eliminates the element that supplies superheated steam into the drying chamber 23 from above the sheet P. Hence, superheated steam does not blow against the upper surface of the sheet P adhered with ink forcefully, preventing the failures such as image dropout on the sheet P.

Additionally, compared to the construction that supplies superheated steam into the drying chamber 23 from above and below the sheet P, each of the drying devices 20 and 20A eliminates the element that supplies superheated steam into the drying chamber 23 from above the sheet P, reducing a number of elements and achieving a simple construction. Each of the drying devices 20 and 20A eliminates the element that supplies superheated steam into the drying chamber 23 from above the sheet P and barely improves drying efficiency of each of the drying devices 20 and 20A as described above. Hence, even if each of the drying devices 20 and 20A eliminates the element that supplies superheated steam into the drying chamber 23 from above and below the sheet P, each of the drying devices 20 and 20A achieves drying efficiency that is equivalent to drying efficiency achieved with the construction that supplies superheated steam into the drying chamber 23 from above and below the sheet P.

Excess superheated steam filling the drying chamber 23 travels upward and is discharged into the exhaust duct 25a of the circulator 25. The exhaust duct 25a communicates with the superheated steam generator 24. Hence, the excess superheated steam discharged from the drying chamber 23 returns to the superheated steam generator 24 and is supplied to the drying chamber 23 again as superheated steam that dries ink adhered to the sheet P.

The superheated steam generator 24 consumes water to generate superheated steam. Hence, the superheated steam generator 24 is to be replenished with water. The circulator 25 reuses excess superheated steam supplied to the drying chamber 23, reducing replenishment frequency of water and improving usability of a user.

The embodiments described above are examples and achieve advantages particular to aspects described below, respectively.

A description is provided of a first aspect of the embodiments of the present disclosure.

In the first aspect, a drying device (e.g., the drying devices 20 and 20A) dries liquid adhered to a liquid bearing medium (e.g., the sheet P). The drying device includes a drying chamber (e.g., the drying chamber 23), a conveyor (e.g., the conveyor 22), and a supplier (e.g., the superheated steam generator 24). The conveyor conveys the liquid bearing medium adhered with the liquid (e.g., ink) through the drying chamber. The supplier supplies superheated steam into the drying chamber from below the liquid bearing medium conveyed by the conveyor. For example, the supplier is disposed below the drying chamber.

A description is provided of a construction of a comparative printer.

The comparative printer includes a printing machine, a dryer, and a cooler. The printing machine prints on a sheet of paper serving as a liquid bearing medium with ink serving as liquid. The dryer, serving as a drying device, dries the ink adhered to the sheet after printing. The cooler cools the sheet ejected from the dryer. The dryer includes a dryer body and a supply component. The dryer body, serving as a drying chamber, is a square chamber. The supply component, serving as a supplier, includes nozzles that blow superheated steam against the dryer body. The nozzles of the supply component blow the superheated steam against both sides (e.g., an upper surface and a lower surface) of the sheet conveyed through the dryer body.

However, the dryer of the comparative printer, that dries the liquid adhered to the liquid bearing medium with the superheated steam, may have a complicated construction.

The drying device (e.g., the dryer) of the comparative printer, that dries the liquid adhered to the liquid bearing medium with the superheated steam, supplies the superheated steam from above and below the liquid bearing medium conveyed through the drying chamber (e.g., the dryer body). Hence, the drying device of the comparative printer may be assumed to dry the liquid adhered to the liquid bearing medium more efficiently than a construction that supplies superheated steam into the drying chamber from above or below the liquid bearing medium. However, superheated steam supplied into the drying chamber tends to travel upward. Hence, superheated steam supplied into the drying chamber from below the liquid bearing medium generates an airflow upward inside the drying chamber. Additionally, superheated steam supplied into the drying chamber from above the liquid bearing medium also tends to travel upward. Accordingly, in order to cause superheated steam supplied from above the liquid bearing medium to contact the liquid bearing medium, the superheated steam is to blow against the upper surface of the liquid bearing medium forcefully.

However, if the superheated steam blows against the liquid bearing medium forcefully, liquid adhered to the upper surface of the liquid bearing medium may move, scatter, or disperse from the liquid bearing medium, causing failures. In view of the failures, the superheated steam supplied from above the liquid bearing medium is not to blow against the liquid bearing medium forcefully. Accordingly, even with the construction that supplies superheated steam from above the liquid bearing medium, the superheated steam may travel upward before the superheated steam contacts the liquid bearing medium. Thus, the drying device of the comparative printer may not dry the liquid adhered to the liquid bearing medium effectively and may barely improve drying efficiency.

Conversely, while superheated steam supplied into the drying chamber from below the liquid bearing medium travels upward inside the drying chamber, the superheated steam comes into contact with the liquid bearing medium successively, improving drying of the liquid on the liquid bearing medium. For example, even with the construction that supplies superheated steam into the drying chamber from above and below the liquid bearing medium, superheated steam supplied into the drying chamber from below the liquid bearing medium substantially dries the liquid on the liquid bearing medium.

Accordingly, the drying device in the first aspect employs the construction that supplies superheated steam into the drying chamber from below the liquid bearing medium. That is, the drying device in the first aspect eliminates an element that supplies superheated steam into the drying chamber from above the liquid bearing medium. Accordingly, compared to the construction that supplies superheated steam into the drying chamber from above and below the liquid bearing medium, the drying device in the first aspect eliminates the element that supplies superheated steam into the drying chamber from above the liquid bearing medium, reducing a number of elements and achieving a simple construction. The eliminated element, that is, the element that supplies superheated steam into the drying chamber from above the liquid bearing medium, barely improves drying efficiency of the drying device as described above. Hence, even if the drying device eliminates the element, the drying device achieves drying efficiency that is equivalent to drying efficiency achieved with the construction that supplies superheated steam into the drying chamber from above and below the liquid bearing medium.

A description is provided of a second aspect of the embodiments of the present disclosure.

In the second aspect, the drying device according to the first aspect further includes a circulator (e.g., the circulator 25) that discharges the superheated steam from the drying chamber and returns the superheated steam to the supplier.

The supplier consumes water to generate superheated steam. Hence, the supplier is to be replenished with water. The circulator reuses excess superheated steam supplied to the drying chamber, reducing replenishment frequency of water supplied to the supplier and improving usability of the user.

A description is provided of a third aspect of the embodiments of the present disclosure.

In the third aspect, the drying chamber of the drying device according to the first aspect or the second aspect includes walls (e.g., the walls 23e) that define the drying chamber. At least a part of the walls is made of a thermal insulating material.

Accordingly, the walls suppress temperature decrease of the superheated steam inside the drying chamber, retaining drying efficiency of the drying device with the superheated steam.

A description is provided of a fourth aspect of the embodiments of the present disclosure.

In the fourth aspect, in the drying device according to any one of the first aspect to the third aspect, the superheated steam inside the drying chamber has a temperature that is not lower than 200 degrees Celsius.

Accordingly, the drying device dries the liquid on the liquid bearing medium with the superheated steam efficiently.

A description is provided of a fifth aspect of the embodiments of the present disclosure.

In the fifth aspect, in the drying device according to any one of the first aspect to the fourth aspect, the conveyor includes a conveying member (e.g., the conveyance belt 22a) that supports a lower surface of the liquid bearing medium and conveys the liquid bearing medium. The conveying member is made of metal as a main material.

Accordingly, the conveying member, that conveys the liquid bearing medium while the conveying member supports the lower surface of the liquid bearing medium, is heated efficiently, thus drying the liquid on the liquid bearing medium with improved efficiently.

A description is provided of a sixth aspect of the embodiments of the present disclosure.

In the sixth aspect, the drying device according to any one of the first aspect to the fifth aspect further includes a heater (e.g., the heater 26) that heats the superheated steam inside the drying chamber.

Accordingly, the heater suppresses temperature decrease of the superheated steam inside the drying chamber, retaining drying efficiency with the superheated steam.

A description is provided of a seventh aspect of the embodiments of the present disclosure.

In the seventh aspect, a liquid discharge apparatus (e.g., the image forming system 100) includes a liquid discharger (e.g., the liquid discharge heads 2a, 2b, 2c, and 2d) and the drying device (e.g., the drying devices 20 and 20A) according to any one of the first aspect to the sixth aspect. The liquid discharger discharges liquid (e.g., ink) onto a liquid bearing medium (e.g., the sheet P). The drying device dries the liquid discharged from the liquid discharger and adhered to the liquid bearing medium.

Accordingly, the liquid discharge apparatus incorporates the drying device that dries the liquid discharged from the liquid discharger and adhered to the liquid bearing medium with sufficient drying efficiency even if the drying device is simplified.

Thus, the drying device dries the liquid adhered to the liquid bearing medium using the superheated steam with a simple construction of the drying device.

According to the embodiments described above, the image forming system 100 is a printer. Alternatively, the image forming system 100 may be a copier, a facsimile machine, a multifunction peripheral (MFP) having at least two of copying, printing, scanning, facsimile, and plotter functions, or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A drying device for drying liquid adhered to a liquid bearing medium, the drying device comprising:
a drying chamber;
a conveyor to convey the liquid bearing medium adhered with the liquid through the drying chamber; and
a supplier disposed below the drying chamber, the supplier to supply superheated steam into the drying chamber.

2. The drying device according to claim 1,
wherein the supplier supplies the superheated steam onto a lower surface of the liquid bearing medium conveyed by the conveyor.

3. The drying device according to claim 2, further comprising a circulator to discharge the superheated steam from the drying chamber, the circulator to return the superheated steam to the supplier.

4. The drying device according to claim 2,
wherein the drying chamber includes walls, at least a part of which includes a thermal insulating material.

5. The drying device according to claim 4,
wherein the walls include:
an upstream wall in a conveyance direction of the liquid bearing medium; and
a downstream wall disposed downstream from the upstream wall in the conveyance direction of the liquid bearing medium,
wherein the drying chamber further includes:
an entry disposed in the upstream wall; and
an exit disposed in the downstream wall, and
wherein the liquid bearing medium borne on the conveyor passes through the entry and the exit of the drying chamber.

6. The drying device according to claim 5,
wherein the walls further include a bottom wall,
wherein the drying chamber further includes an opening disposed in the bottom wall, and
wherein the supplier includes a steam outlet communicating with the opening of the drying chamber.

7. The drying device according to claim 2,
wherein the superheated steam inside the drying chamber has a temperature that is not lower than 200 degrees Celsius.

8. The drying device according to claim 2,
wherein the conveyor includes a conveying member to support the lower surface of the liquid bearing medium, the conveying member to convey the liquid bearing medium.

9. The drying device according to claim 8,
wherein the conveying member includes metal as a main material.

10. The drying device according to claim 8,
wherein the conveying member includes one of a perforated belt and a mesh belt.

11. The drying device according to claim 2, further comprising a heater to heat the superheated steam inside the drying chamber.

12. The drying device according to claim 1,
wherein the supplier includes a superheated steam generator.

13. A liquid discharge apparatus comprising:
a liquid discharger to discharge liquid onto a liquid bearing medium; and
a drying device to dry the liquid adhered to the liquid bearing medium,
the drying device including:
a drying chamber;
a conveyor to convey the liquid bearing medium adhered with the liquid through the drying chamber; and
a supplier disposed below the drying chamber, the supplier to supply superheated steam into the drying chamber.
